(19) United States
(12) Patent Application Publication
(10) Pub. No.: US 2010/0310891 A1
(43) Pub. Date: Dec. 9, 2010

(54) Compositions Based on C4-C7 Secondary Aliphatic Alcohol Esters of Cyclohexanecarboxylic Acids

(76) Inventor: Allen D. Godwin, Seabrook, TX (US)

Correspondence Address: EXXONMOBIL CHEMICAL COMPANY, 5200 BAYWAY DRIVE, P.O. BOX 2149, BAYTOWN, TX, 77522-2149, US

(21) Appl. No.: 12/742,499

(22) PCT Filed: Oct. 23, 2008
(86) PCT No.: PCT/US08/80893

§ 371 Date: Aug. 4, 2010

Related U.S. Application Data
(60) Provisional application No. 60/991,307, filed on Nov. 30, 2007.

(51) Int. Cl. C08K 5/12; B32B 27/30

(52) U.S. Cl. 428/520; 524/296

(57) ABSTRACT

C4-C7 secondary aliphatic alcohol esters of cyclohexanediacid are especially useful as plasticizers for PVC. In embodiments, these fast fusing plasticizers are useful in plastisol formulations to help improve the processability of flexible PVC material. In preferred embodiments these same plasticizers can be used in blends with other plasticizers, especially slower fusing plasticizers or plasticizers with reduced solvency, such as di-2-propylheptyl phthalate or di-isononyl cyclohexanedicarboxylic acid, to improve processability.

### CROSS REFERENCE TO RELATED APPLICATION

This application claims the benefit of Provisional Application No. 60/991,307, filed Nov. 30, 2007, the disclosure of which is incorporated by reference.

### FIELD OF THE INVENTION

The invention relates to compositions based on esters of secondary aliphatic alcohols with cyclohexanecarboxylic acids.

### BACKGROUND OF THE INVENTION

Plasticizers based on cyclohexane diesters were described in the patent literature at least as early as 1937, in U.S. Pat. No. 2,070,770. This class of plasticizers was described as being useful for nitrocellulose plasticization. The cyclohexane diester dibuty hexahydrophthalate or alternatively called dibutyl cyclohexanediacid ester, sold under the brand name Hydropalate B and at one time available from Deutsche Hydrierwerke AG, is taught as a “gelatinizer for cellulose nitrate but not for cellulose acetate” in Plasticizers, by D. N. Buttrey, Leaver-Hume Press LTD, London, 1950, pp. 16-27.

U.S. Pat. No. 2,311,259 describes cyclohexanoates, including the cyclohexanol ester thereof. The problem with this product, a solid at room temperature, is that it is inefficient as a plasticizer (meaning it requires a large amount to provide a plasticizing effect), has poor low temperature flexibility, and is not a good viscosity depressant in plasticisols.

Very little additional information appeared on these types of plasticizers until around 1960, following the commercialization by Union Carbide of their cyclohexane diester of 2-ethyl hexanol plasticizer Flexol™ 55-CC. This plasticizer was alternatively described in as di-2-ethylhexyl hexahydrophthalate, and it was reported as being useful in flexible PVC plasticization. This material, otherwise known as di-2-ethylhexyl cyclohexanediacid ester, is described in Industrial Plasticizers by Ibert Mellan, The Macmillan Company, New York, 1963, pages 190-191. Specifically, the synthesis of Flexol CC-55 is set forth and described as a primary plasticizer for vinyl chloride resins, and said to compare favorably with dioctyl phthalate (DOP) in many basic properties. The PVC plasticized thereby it said to be processable by calendering, extruding, and molding, and as a plastisol. It is also described as compatible with a number of polymers, including polyvinyl acetate, polyvinyl butyral, polystyrene, and chlorinated and brominated rubber.

In the late 1990's and early 2000's, BASF, ExxonMobil, and others described compositions based on cyclohexanoate, cyclohexanedioates, and cyclohexanepolyoate esters, said to be useful for a range of goods from semi-rigid to highly flexible materials. See, for instance, WO 99/32427, WO 2004/046078, WO 2003/029339, WO 2004/046078, U.S. Application No. 2006-0247461, and U.S. Pat. No. 7,297,738.

Phthalate ester plasticizers based on secondary alcohols have also been known since the 1950's. Once such product was di-capryl phthalate, mentioned in D. N. Buttney's text, supra. The problem with this product, among others, is that it is based on capryl alcohol (C8 alcohol with substitution almost exclusively at the 2-position), which is a by-product of sebacic acid production, and hence its availability is limited. This plasticizer was used, for instance, in polyvinyl chloride foam products with silicone polymers. See U.S. Pat. No. 3,795,634. Dicapryl phthalate or DCP is particularly known as a plasticizer giving low, stable viscosities in plastisol formulations versus viscosities that can be obtained with other esters. See, for instance, The Technology of Plasticizers, J. Kern Sears and Joseph Darby, John Wiley & Sons, 1982 p. 349.

Work in the 1960-70's confirmed that secondary alcohol phthalate esters are good plasticizers provided that the hydroxyl group is positioned predominately at the 2-position. See J. W. Hayden, Soc. Plastic. Eng., Annual Tech. Conference., Tech Papers, 28th (1970), pages 46-47 (SPE Publisher, Greenwich, Conn.).

Despite all the above-mentioned work, an efficient plasticizer that can be easily and inexpensively manufactured is still being sought.

The present inventor has surprisingly discovered that C4, C5, C6, and/or C7 secondary aliphatic alcohol esters of cyclohexanecarboxylic acids are efficient as plasticizers in PVC and other polymer systems, and in embodiment provide improvements over other plasticizers in numerous properties.

### SUMMARY OF THE INVENTION

The invention is directed to compositions comprising C4-C7 secondary aliphatic alcohol esters of cyclohexanecarboxylic acids, including cyclohexanemonocarboxylic acid esters, and cyclohexanepolycarboxylic acid esters.

In embodiments the compositions further comprise at least one plasticizable polymer, such as polyvinyl chloride, polyvinyl acetate, polyvinyl butyral, polystyrene, polyurethanes, acrylics, chlorinated rubber, brominated rubber, and polyolefins.

Particularly preferred embodiments are PVC compositions comprising at least one C4-C7 secondary alcohol esters of cyclohexanepolycarboxylic acids. In still more preferred embodiments, the cyclohexanepolycarboxylic acid esters are dicarboxylic acid esters based on the 1,2- or 1,4 cyclohexandedicarboxylic acid esters of C4 to C7 secondary alcohols.

In embodiments, the esters according to the invention are prepared from the catalytic hydrogenation of the corresponding esters prepared from the same secondary alcohols and phthalic acid or anhydride, or terephthalatic acid or dimethyl terephthalate or trimellitic anhydride, wherein the aromatic acid moiety is hydrogenated after esterification with the secondary alcohol. In other embodiments, the esters according to the invention can be prepared by esterification of hexahydrophthalic anhydride and/or hexahydroterephthalic acid with C4-C7 secondary alcohols. In other embodiments, the esters according to the invention can be prepared by esterification of hexahydrophthalic anhydride and/or hexahydroterephthalic acid with C4-C7 secondary alcohols. In other embodiments, the ester according to the invention can be prepared by the esterification of C4-C7 alkenes with 1,2 hexahydrophthalic acid.

In other embodiments, these plasticizers are useful in plastisol formulations to help improve processability of flexible PVC materials and products.

In still other embodiments, these secondary alcohol esters are used as viscosity depressants, particularly in plastisols.

In preferred embodiments these same plasticizers can be used in blends with other plasticizers, especially slower fusing plasticizers or plasticizers with reduced solvency, such as di-isodecyl phthalate, di-isononyl phthalate, di-isononyl cyclohexanedicarboxylic acid ester, di-isodecyl cyclohexanedicarboxylic acid ester, di-2-propyl heptyl phthalate, di-2-propylheptyl cyclohexanedicarboxylic acid ester, di-2-ethyl hexyl terephthalate, and the like, to improve processability of PVC compositions.

In embodiments, the cyclohexanedicarboxylic acid esters of C4, C5, C6, and C7 secondary aliphatic alcohols, and mixtures thereof, are particularly useful as fast fusing plasticizers. The C4-C7 esters are more strongly solvating plasticizers for PVC relative to cyclohexanediacid esters of C8, C9, and C10 branched or linear, primary or secondary alcohols, such as di-isodecyl cyclohexanedicarboxylic acid ester or di-isononyl cyclohexanedicarboxylic acid ester or di-2-ethylhexyl cyclohexanedicarboxylic acid ester.

It is an object of the present invention to provide more efficient plasticizers in polymer systems such as polyvinyl chloride, polyvinyl acetate, polyvinyl butyral, polystyrene, and chlorinated and brominated rubber.

It is another object of the invention to provide fast fusing plasticizers for PVC either as the primary plasticizer or in combination with slower fusing plasticizers.

It is still another object of the invention to provide compositions useful compositions comprising C4-C7 secondary aliphatic alcohols as solvents for fats, oils, waxes, gums, resins, lacquer solvent, perfumes, industrial odorants, dispersants for herbicides, detergents, and as wetting agents.

These and other objects, features, and advantages will become apparent as reference is made to the following detailed description, preferred embodiments, examples, and appended claims.

### DETAILED DESCRIPTION OF THE INVENTION

According to the invention, compositions comprising at least ester selected from the group consisting of C4, C5, C6, and C7 secondary aliphatic alcohol esters of cyclohexanecarboxylic acid are provided.

In embodiments, the compositions comprise a plasticizing amount of said esters in polymer system, wherein the polymer is selected from the group consisting of polyvinyl chloride, polyvinyl acetate, polyvinyl butyral, polystyrene, and chlorinated and brominated rubber, and mixtures thereof.

In other embodiments, said esters are used in plastisol formulations to help improved processability of flexible PVC material.

Terms used herein take their ordinary definition in the art unless otherwise defined, e.g., the term “secondary aliphatic alcohol” means that the alcohol group (—OH) is attached to a carbon that is itself attached to two other carbons and one hydrogen, and that the carbon chain is open rather than cyclic. In embodiments the alcohols will include a mixture of isomers, e.g., wherein the alcohol group is at the second or third carbon atom, and the carbon chain may be linear or branched, with lightly branched C4-C7 secondary alcohols, i.e., having an average of 0.8 to 1.6 branches per chain, being preferred over more highly branched secondary alcohols. In embodiments the secondary aliphatic alcohols are predominantly linear, wherein the term predominantly means that more than 50 mol % of the alcohol moieties are linear. In other embodiments, the cyclic secondary alcohol content is less than 20% of the secondary alcohols, preferably less than 10% of the secondary alcohols, more preferably less than 2% of the secondary alcohols.

The term cyclohexanecarboxylic acid esters as used herein is intended to include the cyclohexane group having at least one carboxylic acid functional group attached directly to the C6 ring, thus including monocarboxylic acid and polycarboxylic acid groups, i.e., dicarboxylic acids, tricarboxylic acids, and so on. The preferred embodiment is the cyclohexanedicarboxylic acid ester of at least one C4-C7 secondary aliphatic alcohols. All possible isomers of polycarboxylic acids are envisioned to be useful, however in preferred embodiments, the dicarboxylic acid isomer with the carboxylic acid groups in the 1,2 substitution position is the preferred isomer. Mixtures of isomers are also envisioned.

Note that the plasticizers of this invention can be described by several different names. For example the cyclohexanediacid ester of the C7 secondary alcohol with the substitution at the C2 position, can also be described as 1,2-Cyclohexanedicarboxylic acid, bis(1-methylhexyl) ester or 2-heptanol cyclohexanedioate, or Bis-(1-methylhexyl)cyclohexanedioate, or di(2-heptyl)cyclohexandioate, or di-sec-heptyl cyclohexanoate. These same esters can also be described as hexahydrophthalate esters, as for example Bis(1-methylhexyl)hexahydrophthalate or 1,2-hexahydrophthalic acid, bis(2-methylhexyl) ester. A C7 alcohol ester plasticizer of this invention with substitution at the C3 position would have similar names, including 1,2-cyclohexanedicarboxylic acid, bis(2-ethylpentyl) ester, or 3-heptanol cyclohexanedioate or Bis-(2-ethylpentyl) cyclohexandioate or di(3-heptyl) cyclohexandioate.

In preferred embodiments, the cyclohexanedicarboxylic acid esters of at least one C4 to C7 secondary aliphatic alcohols are particularly useful as fast fusing plasticizers, and even more particularly, they are useful as fast fusing plasticizers in mixtures with slower fusing plasticizers and/or with weaker solvating plasticizers, especially slower fusing plasticizers (or plasticizers with reduced solvency) such as di-2-propylheptyl phthalate or di-isononyl cyclohexanedicarboxylic acid, to improve processability of PVC compositions.

Fast fusing plasticizers are those plasticizers which, in preferred embodiments, offer an improvement in flexible PVC product processing or manufacturing speeds or in reduced PVC fusion temperatures, compared to some standard of reference. When a plasticized PVC product is produced, it must reach a temperature during fabrication at which point the PVC crystallites are melted. This is called the fusion temperature and depending upon the plasticizer and the type of PVC resin, this temperature generally ranges from 160 to 180° C. Plasticizers which are better solvents for PVC will fuse at lower temperatures than those that are poorer solvents. Since many flexible PVC products are produced through continuous processes, those faster or stronger solvating plasticizers will arrive at this fusion temperature faster; hence the development of the descriptor “fast fusing”. These same plasticizers are also known as strong solvating plasticizers. For most applications, the plasticizer reference standard is di-2-ethylhexyl phthalate (DEHP) as this plasticizer has been the most widely used plasticizer world wide since it was commercialized in the late 1930's. Plasticizers which fuse at lower temperatures than that required for DEHP, at the same concentration, are considered fast fusing plasticizers. Likewise, plasticizers that fuse at higher temperatures than that required for DEHP, at the same concentration, are considered “slow fusing” plasticizers.

Part of the concept of faster fusing plasticizers can be demonstrated through the use of a simple test procedure, called PVC solution temperature. In this test, 48 grams of plasticizer is mixed with 2 grams of PVC resin at room temperature. The mixture is slowly heated, with stirring, until the PVC resin dissolves. The temperature at which the PVC resin dissolves in the plasticizer is recorded as the “solution temperature. The C4-C7 secondary aliphatic alcohol cyclohexanedicarboxylic acid esters have lower solution temperatures than that of the standard product DEHP and are thus “faster fusing”.

Although this solution temperature is cited as an example, other techniques can be used to demonstrate the same effect, for example hot bench gelation or through the use of Dynamic Mechanical analysis of the plastisol during a temperature sweep, as described by Paul Daniels, et. al., “Meaningful Evaluation of Plastisol Gelation and Fusion Temperatures by Dynamic Mechanical Analysis, Journal of Vinyl Technology, December 1986, Vol. 8(4), pp. 160-163.

The term “fast fusing plasticizer”, as used herein, is defined as follows. Using the solution temperature for the C8 phthalate ester DEHP as the standard, those plasticizers with lower solution temperatures, at a given concentration and for a given polymer system, are described as “fast fusing plasticizers” or strong solvating plasticizers, while those with higher fusion temperatures are considered slower fusing plasticizers or less solvating plasticizers. Common examples of plasticizers promoted today as fast fusing plasticizers include butyl benzyl phthalate (BBP), diisoheptyl phthalate, dihexyl phthalate, dibutyl phthalate, dibenzoate esters of diethylene glycol or dipropylene glycol, and benzoate esters of C8 or C9 or C10 branched primary alcohols.

Fast fusing/strong solvating plasticizers are desired in many PVC processes, as they enable high quality flexible PVC products to be made efficiently. These fast fusing or strong solvating plasticizers can be used either as the sole primary plasticizer in the flexible PVC formulation or the plastisol composition, or they can be used to improve the processability or to reduce the fusion or processing temperature of PVC formulations or plastisol compositions that are based on less solvating plasticizers as the primary plasticizer.

Examples of preferred fast fusing plasticizers of the present invention include the C4-C7 secondary aliphatic alcohol diacid esters of 1,2 cyclohexanediacid (or hexahydrophthalic acid), cyclohexane anhydride (or hexahydrophthalic anhydride), 1,4 cyclohexanediacid (or hexahydroterephthalic acid), 1,3 cyclohexanediacid (or hexahydroisopthalic acid), and mixtures thereof. For the secondary aliphatic alcohol, the preferred moiety includes at least one of 2-heptanol, 2-hexanol, 2-pentanol, 2- and 3-pentanol, 2- and 3-hexanol, 2- and 3-heptanol, and mixtures thereof. The combination of any of the acid moieties and any of the alcohol moieties in this paragraph represent the more preferred embodiments as fast fusing plasticizers for polymer systems, especially for systems comprising PVC as the polymer.

In cases where there is a mixture of isomers of the alcohol moiety, other especially preferred embodiments are mixtures where the ratio of secondary alcohols wherein the hydroxyl group is position at the C2 to secondary alcohols wherein the hydroxyl group at the C3 position is 2/1 or greater, more preferably greater than 2/1, and still more preferably 3/1 or greater, and yet still more preferably 4/1 or greater.

Although the examples cited above imply straight chain alcohols, this invention also applies to the corresponding branched products, as previously mentioned. Blends of branched and linear alcohols, such as mixtures of C6 and C7 secondary aliphatic alcohols, each independently selected from branched and/or linear alcohols, or C5 and C6 secondary aliphatic alcohols, each independently selected from branched and/or linear alcohols, and also C4, C5, C6, and C7 secondary aliphatic alcohols, each independently selected from branched and/or linear aliphatic alcohols, are also useful to make these plasticizers. Other mixtures, such as of C4 and C6, or C4 and C7, or C4, C6, C7, or C5, C6, C7, or C5 and C7, each independently selected from branched and/or linear aliphatic alcohols, are also envisioned. This description, of course, refers to the starting alcohol reagent used in the esterification reaction, and also describes the resultant alcohol moiety attached to the cyclohexanecarboxylate group.

In embodiments wherein there is a mixture of linear alcohols and branched alcohols, it is preferred that the ratio of linear to branched is 2/1 or greater, more preferably greater than 2/1, and still more preferably 3/1 or greater, and yet still more preferably 4/1 or greater.

In other embodiments, branched secondary aliphatic alcohols may be used along with linear secondary aliphatic alcohols provided that the overall branching as measured by NMR techniques, is less than 1.8 branches per molecule, more preferably less than 1.5 branches per molecule, and still more preferably less than 1.0 branches per molecule. In preferred embodiments, as previously mentioned, there is no lower limit on branching (zero, or completely linear, is a preferred embodiment), while in other preferred embodiments, the lower limit is 0.4 or 0.5, or 0.6, or 0.8 branches per chain, on average. Any range from any lower limit (including zero) to any upper limit set forth herein are also envisioned as embodiments, e.g., 0 to less than 1.5 branches, 0.6 to less than 1.0 branches, and so on. The particular technique used to calculate the branching is not particularly critical. The NMR technique used to measure branching is per se known in the art. See, for instance, WO 2006012989.

The esters of this invention can be prepared by hydrogenation of the corresponding aromatic ester, such as a phthalate, terephthalate, or isophthalate made with the C4 to C7 secondary alcohols or by esterification of the corresponding cyclohexane acid or cyclohexane polyacid or anhydride with the alkyl alcohol types described above. The esters of this invention can also be prepared by the esterification of cyclohexane polyacids and/or anhydride. See also WO2004/046078. The cyclcohexane polyacids and anhydrides can be prepared by hydrogenation of the corresponding aromatic acid or anhydride, such as hydrogenation of phthalic anhydride or in the case of hexahydrophthalic anhydride, can be prepared through a direct route, such as the Diels Alder synthesis, using butadiene and maleic anhydride, followed by hydrogenation of the double bond. In other embodiments, the esters according to the invention can be prepared by esterification of hexahydrophthalic anhydride and/or hexahydroterephthalic acid with C4-C7 secondary alcohols. In other embodiments, the ester according to the invention can be prepared by the esterification of C4-C7 alkenes with 1,2 hexahydrophthalic acid. Numerous esterification techniques are known in the art, e.g., such as disclosed in Volume 9 of the Kirk-Othmer Encyclopedia of Chemical Technology, Fourth Edition (1994), pp. 762-768. Preferred catalysts include titanium organometallic catalysts such as those per se well known in the art, e.g., U.S. Pat. No. 6,355,817 and U.S. Patent Application No. 20050038283.

The diacid plasticizers of this invention are particularly useful, either as the sole primary plasticizer or in blends with other plasticizers, such as phthalates, benzoates, polyester polymeric plasticizers prepared, for instance, from the condensation of adipic acid with other polyols, alcohols, and acids, other cyclohexanediacid esters, and terephthalates, which in embodiments improves the processability and/or the properties of PVC compounds based in part on those plasticizers. These esters and diesters are particularly useful in plastisol compositions. In embodiments, they offer advantages of yielding lower plastisol viscosities versus those plasticizers prepared from 1-substituted branched chain (primary) alcohols such as di-isoheptyl phthalate, di-isononylcyclohexanedioate, di-isononyl phthalate, di-2-propyl heptyl phthalate, or di-isodecyl phthalate, and will help reduce the fusion temperature

In products designed for outdoor applications, these secondary aliphatic alcohol esters are useful in offering improved UV stability for plasticized PVC articles and products over those produced with phthalates esters. These products are also useful in toy manufacturing, especially for toys produced in rotomolding processes, where their low viscosity and faster fusion properties would be an advantage. Other examples where these products are useful include vinyl resilient flooring, vinyl backed carpeting, wall paper, automotive air filters, coated fabrics, dip molded products such as gloves, T-shirt inks, and foamed PVC products (e.g., floor mats).

In one embodiment of this invention, these C4-C7 secondary aliphatic alcohol esters of cyclohexanecarboxylic acid plasticizers can be mixed with PVC suspension resin, in concentrations ranging from 5 phr to 100 phr, and can be used in combinations with other additives such as calcium carbonate fillers, Ca/Zn and Ba/Zn stabilizers, epoxidized soy bean oil, lubricants, pigments and dies or other colorants, antioxidants, other plasticizers and stabilizers. In this embodiment, the total plasticizer concentration will range from 25 parts 100 phr, preferably 35 to 80 phr. The PVC compositions of this embodiment can be processed into products through injection molding, extrusion, calendering, and rotomolding.

In another embodiment of this invention, plastisols can be prepared with these C4-C7 secondary aliphatic alcohol esters of cyclohexanecarboxylic acid plasticizers, where in mixtures with PVC paste or emulsion resin, the concentrations of the plasticizers of this invention can range from 20 phr to 100 phr, and can be used with other additives such calcium carbonate fillers, Ca/Zn and Ba/Zn stabilizers, epoxidized soy bean oil, lubricants, pigments and dies or other colorants, antioxidants, PVC blending resins, viscosity or flow additives, diluents, other plasticizers and stabilizers. For plastisols, the total concentration of liquids including plasticizers, stabilizers, and viscosity control additives will range from 40 phr to 150 phr. Plasticisols can be processed into flexible PVC products through techniques such as rotomolding, dipping, spreading, spraying, casting, or cavity molding.

Secondary aliphatic alcohol cyclohexanepolyoate esters such as describe above are also useful in other applications such as solvents for printing inks, coalescent agents for film forming polymers (latex paints, floor polishes, adhesives, sealants), blank wash (printing), ag chem solvents and emulsifiable concentrates, drilling fluids, lubricants, cosmetics, solvents for fuel and lube additives, emollients, and personal care applications, In addition, these esters would be useful as plasticizers for other non-PVC polymers, including polyurethanes, acrylics, polypropylene, EDPM, thermoplastic elastomers, and other polyolefins.

The products according to the present invention may be used with other fast fusing or strong solvating plasticizers. Examples of these fast fusing plasticizes include dibutyl phthalate, dihexyl phthalate, butyl benzyl phthalate, butyl octyl phthalate, diethylene glycol dibenzoate, dibutyl terephthalate, dipropylene glycol benzoate, and alkyl sulfonate esters of phenol. The products of the present invention offer similar advantages to other fast fusing plasticizers in processing, such as having faster processing speeds or lower oven/heating temperatures. Temperature can be a limitation in coating products such as paper or carpet fibers where a lower fusing temperature allows these materials to be used without experiencing thermal decomposition. Lower operating temperatures are also advantaged in having lower heating costs, for example in automotive underbody sealants and coatings. Faster fusing also yields advantages in processing speeds, such as for coated fabrics, sheet flooring, glove dipping, underbody automotive sealants, and rotomolding.

However, in addition to offering the same qualities as other fast fusing plasticizers, the cyclohexanediacid esters of secondary aliphatic alcohols of the invention offer the advantage of plastisol viscosity reduction. Reduction is plastisol viscosity is desired as it allows for coating processes to operate at faster line speeds; this is important to the production of vinyl sheet flooring, coated fabrics, and wall paper.

The cyclohexanediacid esters of secondary aliphatic alcohols of the invention offer the advantage of improved viscosity stability of PVC plastisols. Often with some fast fusing plasticizers such as butyl benzoate, because this material is a strong solvent for PVC, plastisols prepared with BBP either as a primary plasticizer or as part of the plasticizer system, will slowly increase in viscosity. This viscosity increase can slow down production and can lead to product failures. Plasticizers of this invention will have good viscosity stability upon storage.

In embodiments, the cyclohexanoates based on C4-C7 secondary aliphatic alcohols may be used as plasticizers in polyvinyl chloride compositions to reduce the amount of plasticizer required and in some cases producing superior properties to those obtained when using phthalates as the plasticizer. By way of non-limiting example, the present invention provides for the use of at least one C4-C7 secondary aliphatic alcohol ester of cyclohexane mono- and/or cyclohexanepolycarboxylic acids as plasticizers for polyvinyl chloride compositions to enable the production of a composition having comparable mechanical properties with a reduced amount of polyvinyl chloride and/or with a reduced amount of plasticizer. In some embodiments the amount of polyvinyl chloride and/or plasticizer can be reduced by 0.05 wt %, 1.5 wt %, 2.0 wt %, 2.5 wt % and 3 wt % or any range thereof resulting in 4 to 7% cost savings at comparably plasticizer price.

In a preferred embodiment, the present invention provides polyvinyl chloride composition based on at least one C4-C7 secondary aliphatic alcohol ester of cyclohexanepolycarboxylic acids as plasticizers having a hardness as measured by the Shore A scale and tensile strength comparable to compositions based on phthalate plasticizers but requiring less polyvinyl chloride than when the phthalate plasticizer is used. This results in considerable economic benefits, especially in products prepared from plastisols.

In other preferred embodiments, C4-C7 secondary aliphatic alcohol ester of cyclohexanepolycarboxylic acids plasticizers are applicable across the range of plasticized polyvinyl chloride materials. These plasticizers are applicable to the production of semi-rigid polyvinyl chloride compositions, which preferably contain from about 10 to about 40 parts, more preferably 15 to 35 parts, still more preferably 20 to 30 parts of plasticizer per 100 parts of polyvinyl chloride. The invention is also applicable to flexible polyvinyl chloride compositions which preferably contain from about 35 to about 70 parts, more preferably 40 to 60 parts per 100 parts of polyvinyl chloride, and also to the highly flexible compositions, which preferably contain from about 70 to about 130 parts, more preferably 70 to 100 parts, still more preferably 70 to 80 parts of plasticizer per 100 parts of polyvinyl chloride. As used herein, parts are given on a weight basis.

The semi-rigid compositions are typically used for the production of pipes, extruded profiles, rigid floor mats, some wire and cable coatings, and floor tiles. Flexible compositions are typically used for the production of sheeting, upholstery, medical tubing, garden hoses, pool liners, water beds, toys and the like. Very flexible compositions are used in the production of coated cloth, toys, shoe soles and the like.

The esters of C4-C7 secondary aliphatic alcohols with cyclohexanepolycarboxylic acid, are particularly useful in the production of medical articles such as blood bags and medical tubing and in toys and in materials used for food contact such as bottle caps and films where di-2-ethyhexyl phthalate has traditionally been used.

In another embodiment, the at least one C4-C7 secondary aliphatic alcohol ester of a cyclohexanemono- or poly-carboxylic acid are used together with other plasticizers. For example, at least one of the esters according to the invention may be used with plasticizers such as adipate esters, phthalate esters, trimellitate esters, benzoic acid esters, aliphatic diacid esters, various polymeric plasticizers, and mixtures thereof. When used in plasticizer blends the relative proportions of the plasticizers that are used will depend upon the desired properties. However it is preferred to use at least 5 wt %, more preferably at least 10 wt %, more preferably at least 15 wt %, more preferably at least 20 wt %, more preferably at least 25 wt %, more preferably at least 30 wt %, more preferably at least 35 wt %, more preferably at least 40 wt %, more preferably at least 45 wt %, more preferably at least 50 wt %, more preferably at least 55 wt %, more preferably at least 60 wt %, more preferably at least 65 wt %, more preferably at least 70 wt %, more preferably at least 75 wt %, more preferably at least 80 wt %, more preferably at least 85 wt %, more preferably at least 90 wt %, of the at least one C4-C7 secondary aliphatic alcohol ester of the cyclohexanemono- and/or poly-carboxylic acids, based on the total weight of plasticizer present. In a preferred embodiment wherein a mixture of plasticizers is used and one of the plasticizers is a phthalate, the mixture preferably comprises no more than 95 wt % cyclohexane polycarboxylic acid according to the invention. Preferred ranges include between 0.01 and 95 wt %, more preferably 5 to 90 wt %, more preferably 10 to 80 wt %, more preferably 20 to 70 wt %, more preferably 30 to 60 wt % of the at least one C4-C7 secondary aliphatic alcohol ester of cyclohexanecarboxylic acids, preferably of cyclohexanepolycarboxylic acids, still more preferably cyclohexanedicarboxylic acid.

The present inventor has also found that the C4-C7 secondary aliphatic alcohol esters of cyclohexanecarboxylic acid impart an improved stability to ultra-violet light when used as plasticizers in polyvinyl chloride compositions. This improved stability leads to longer service life for materials made from the polyvinyl chloride especially in an environment where they are subjected to sunlight. Throughout this application ultra-violet light stability is measured in the QUV test which is ASTM G 53-84. This is particularly useful where the plasticized polyvinyl chloride composition is to be used in outdoor applications. In particular, this is useful in applications such as roofing, tarpaulins and tents, films such as adhesive tapes and agricultural films, shoes and automobile interiors.

In a further embodiment the present invention therefore provides a plasticized polyvinyl chloride composition preferably containing from about 20 to about 100 parts by weight, more preferably 30 to 90 parts by weight, still more preferably 40 to 80 parts by weight, yet still more preferably 50 to 70 parts by weight of a plasticizer composition containing one or more cyclohexane carboxylic acid esters of at least one C4-C7 secondary aliphatic alcohol esters of cyclohexane mono- or polycarboxylic acids, as plasticizer per 100 parts of polyvinyl chloride said composition having a stability to ultra-violet light indicated by the low development of color in the QUV test over 456 hours in a formulation containing 100 parts of Solvic 367 polyvinyl chloride polymer, 50 parts of plasticizer according to the invention, 5 parts of Durcal calcium carbonate filler and 2 parts of LZB 320 stabilizer.

In a further embodiment the present invention provides the use of a plasticized polyvinyl chloride composition preferably containing from about 20 to about 100 parts by weight, more preferably 30 to 90 parts by weight, still more preferably 40 to 80 parts by weight, yet still more preferably 50 to 70 parts by weight of a plasticizer composition containing one or more C4-C7 secondary aliphatic alcohol esters of a cyclohexanemono- and/or poly-carboxylic acids as plasticizer, per 100 parts by weight of polyvinyl chloride, in the production of articles, said composition having a stability to ultra-violet light, as indicated by the low development of color in the QUV test over 456 hours in a formulation containing 100 parts of Solvic 367 polyvinyl chloride, 50 parts of plasticizer according to the invention, 5 parts of Durcal calcium carbonate filler and 2 parts of LZB 320 stabilizer.

In a further embodiment, the invention provides roofing, tarpaulins, tents, films, sheeting, floor covering, shoes and automobile interiors obtained from a plasticized polyvinyl chloride composition, preferably containing from about 20 to about 100 parts by weight, more preferably 30 to 90 parts by weight, still more preferably 40 to 80 parts by weight, yet still more preferably 50 to 70 parts by weight, of a plasticizer composition containing one or more cyclohexanemono- and/or poly-carboxylic acid esters of at least one C4-C7 secondary aliphatic alcohols, per 100 parts of polyvinyl chloride.

One widespread use of polyvinyl chloride is as a plastisol, as previously mentioned. A plastisol may be described as a fluid or a paste consisting of a mixture of polyvinyl chloride and a plasticizer, optionally containing various additives. A plastisol is used to produce layers of polyvinyl chloride which are then fused to produce coherent articles of flexible polyvinyl chloride. Plastisols are useful in the production of flooring, tents, tarpaulins, coated fabrics such as automobile upholstery, in car underbody coatings, in moldings and other consumer products. Plastisols are also used in footwear, fabric coating, toys, flooring products and wallpaper. Plastisols typically contain about 40 to about 200 parts by weight, more typically 50 to 150 parts by weight, more typically 70 to 120 parts by weight, more typically 90 to 110 parts by weight of plasticizer per 100 parts of polyvinyl chloride. In an embodiment, at least one of the C4-C7 secondary aliphatic alcohol esters of cyclohexanecarboxylic acids may replace a portion of all of the traditional plasticiser used.

Plastisols are usually made from polyvinyl chloride polymer that has been produced by emulsion polymerization or by micro suspension polymerization techniques. The plastisol may be produced by the manufacturer of the polyvinyl chloride or by a compounder and shipped to the user in fluid form. Alternatively the plastisol may be produced by the user. In either instance, although particularly when the plastisol is produced by the manufacture of the polyvinyl chloride or a compounder, it is important that the plastisol viscosity be stable over time.

Phthalate esters are widely used as plasticizers in plastisols. However, plastisols based on phthalate ester plasticizers suffer from the disadvantages that the viscosity of the plastisol can be undesirably high and that the viscosity of the plastisol can increase to an undesirable extent over time. The present inventor has found that when the cyclohexanemono- and/or poly-carboxylic acid esters of at least one C4-C7 secondary aliphatic alcohols are used as the plasticizer the plastisols also have improved viscosity stability over time, furthermore they also have improved or lower viscosity. This is particularly useful where the plastisol is to be stored for sometime between production and use, for example when it is used in coating applications.

The present invention therefore provides a plastisol composition containing at least one C4-C7 secondary aliphatic alcohol ester of cyclohexane mono- and/or polycarboxylic acid, preferably in the amount of from about 40 to about 200 parts by weight, more preferably 50 to 150 parts by weight, still more preferably 70 to 120 parts by weight, yet still more preferably 90 to 110 parts by weight of total plasticizer per 100 parts of polyvinyl chloride, wherein the plasticizer comprises one or more C4-C7 secondary aliphatic alcohol ester of a cyclohexane polycarboxylic acid ester. Other plasticizers mentioned herein may be included in the total plasticizer limit, such as slower fusing plasticizers. In embodiments, the plasticizer consists of the at least one C4-C7 secondary aliphatic alcohol ester of a cyclohexane polycarboxylic acid, allowing for inevitable impurities.

In a further embodiment, the present invention provides a process for the production of flexible polyvinyl chloride comprising forming a layer from a plastisol containing from 40 to 200 parts by weight preferably 50 to 150 parts by weight, more preferably 70 to 120 parts by weight, more preferably 90 to 110 parts by weight of a plasticizer composition containing one or more C4-C7 secondary aliphatic alcohol ester of a cyclohexanepolycarboxylic acid esters per 100 parts by weight of polyvinyl chloride and subsequently fusing the layer by the application of heat.

The use of the at least one C4-C7 secondary aliphatic alcohol ester of a cyclohexanepolycarboxylic acid as a plasticizer for polyvinyl chloride compositions also provides improved cold flex properties over what can be obtained through the use of phthalate esters of similar molecular weight. Cold flex measurements give an indication of the lowest temperature that the flexible PVC product can be used without cracking or breaking. An improvement in Cold Flex temperature leads to an improved service temperature range and is particularly useful in the production of articles used in a wide range of temperatures. Throughout this application the cold flex properties are measured using the Clash and Berg test (ASTM D 1043-84) and the ASTM D 746 brittleness test. The improved cold flex is particularly useful when the plasticized polyvinyl chloride composition is to be used in articles which are used over a wide temperature range. In particular this is useful in applications such as roofing, tarpaulins and tents, protective films including food wrap films, wire and cable, coated fabrics, shoes and medical applications such as blood bags and tubing.

The present invention therefore provides a plasticized polyvinyl chloride composition containing from 20 to 100 parts by weight preferably 30 to 90 parts by weight, more preferably 40 to 80 parts by weight, more preferably 50 to 70 parts by weight of a plasticizer composition containing one or more C4-C7 secondary aliphatic alcohol esters of a cyclohexanepolycarboxylic acid ester per 100 parts of polyvinyl chloride having a cold flex below −20° C. as measured by the Clash and Berg test on a formulation of 100 parts of Solvic 271 GC polyvinyl chloride, 150 parts of plasticizer, 80 parts of calcium carbonate filler EXH 1SP from Omya, 6 parts of Tribasic lead stearate and 1 part of dibasic lead stearate.

Viscosity control is important in the conversion of these plastisols into useful products. For example in the preparation of vinyl floor coverings, the plastisol is spread on a surface moving at around 15 to 25 meters per minute in several layers so that the floor covering is literally built up. Typically these layers include a foam core, a decorative layer and a clear protective wear layer. The multilayer products are first gelled by contact with a heated roll and then passed into an oven where they are fused (gelled) at a temperature of from 180° C. to 200° C. Often the gelling is performed after the spreading of each individual layer, starting with the base or encapsulation layer. After the gelling, the next layer can be spread. When all layers have been spread, the product is then passed into an oven to obtain full fusion of all layers together and adequate expansion of the foamed layers.

To obtain the low plastisol viscosity needed for the production of high quality flooring products, there are several approaches; among which include adding a viscosity depressant, adding higher levels of plasticizer, or varying the PVC resin system such as with partial substitution of specialty PVC blending resins or PVC copolymers. Viscosity depressants such as Texanol™ isobutrate sold by Eastman Chemical or Exxsol™ D110 sold by ExxonMobil Chemical or Jayflex™ 215 also sold by ExxonMobil Chemical, and specialty esters based on oleates, laurates, and benzoates such as described in WO97/035060 can be used, but these can contribute to higher emissions during processing and can impact indoor air quality. Higher levels of added plasticizer will reduce the plastisol viscosity, but this can lead to increased staining in the top layer or partial collapse of the foam layer. Traditional plasticizers used in PVC flooring include diisononyl phthalate, diisodecyl phthalate, di-2-ethylhexyl phthalate, diisoheptyl phthalate, butyl benzyl phthalate and dipropylene gylcol dibenzoate mixtures. Substitution of these plasticizers, in whole or in part, with the C4-C7 secondary aliphatic alcohol cyclohexanediacid esters of this invention, will give PVC flooring products that processes easily and do not have the emission problems associated with the use of plastisol viscosity depressants.

In yet a further embodiment the invention provides a plasticized polyvinyl chloride composition comprising polyvinyl chloride and from 20 to 200 preferably 40 to 180, more preferably 60 to 160, more preferably 80 to 140, more preferably 100 to 120 parts per 100 parts of polyvinyl chloride of a plasticizer composition comprising a plasticizer other than an ester of a cyclohexane carboxylic acid ester and at least one C4-C7 secondary aliphatic alcohol ester of a cyclohexane carboxylic acid wherein the amount of said at least one C4-C7 secondary aliphatic alcohol ester of a cyclohexane carboxylic acid is greater than 5 wt % of the total plasticizer content.

The present inventor has found that levels above 5 wt % of C4-C7 secondary aliphatic alcohol ester of a cyclohexanecarboxylic acid provides a significant reduction in viscosity of the plasticizer composition. It is preferred to use from, 5 to 50 wt % of said ester, more preferably from 7 to 30 wt %, more preferably from 10 to 20 wt % based on the total weight of plasticizer.

In a preferred system 5 to 20, preferably 7 to 15, more preferably 10 to 15 wt % of total phthalate of the C4-C7 secondary aliphatic alcohol esters of cyclohexanoic polycarboxylic acids particularly di-secheptyl cyclohexane dicarboxylic acid may be used to replace traditional viscosity depressants used in phthalate based formulations such as Jayflex™ 215. The use of the ester of cyclohexane polycarboxylic acid will have the added benefit that the ester will also have a plasticizing effect and will not yield high levels of emissions during processing.

Where the at least one C4-C7 secondary aliphatic alcohol ester of a cyclohexanemonocarboxylic acid is to be used in conjunction with a primary plasticizer to act as a viscosity depressant the primary plasticizers may be any of those conventionally used for plasticizing chlorine containing resins. These include dialkyl esters of phthalic anhydrides and cycloalkane dicarboxylic acids with monohydric alcohols having from 4 to 13 carbon atoms, dibenzoate esters, alkyl esters of aromatic tri- or tetra-carboxylic acids and aliphatic dicarboxylic acid with monohydric alcohols having 3 to 12, preferably 3 to 10, carbon atoms.

Examples of suitable benzenepolycarboxylic acids or a derivatives thereof with which the esters of the secondary aliphatic alcohol cyclohexane carboxylic acid esters may be used are the alkyl terephthalates such as, di-n-butyl terephthalate, monoglycol esters of terephthalic acid, diglycol esters of terephthalic acid, di-n-octyl terephthalate, diisooctyl terephthalate, di-2-ethylhexyl terephthalate, di-n-nonyl terephthalate, diisononyl terephthalate, di-n-decyl terephthalate, di-n-undecyl terephthalate, diisodecyl terephthalate, and/or di-2-propylheptyl terephthalate,

Another suitable class are the alkyl phthalates such as, monoglycol esters of phthalic acid, diglycol esters of phthalic acid, di-n-octyl phthalate, diisooctyl phthalate, di-2-ethylhexyl phthalate, di-n-nonyl phthalate, diisononyl phthalate, di-n-decyl phthalate, diisodecyl phthalate, di-2-propylheptyl phthalate, di-n-undecyl phthalate, diisododecyl phthalate, dicyclohexyl phthalate; alkyl isophthalates such as, di-n-octyl isophthalate, diisooctyl isophthalate, di-2-ethylhexyl isophthalate, di-n-nonyl isophthalate, diisononyl isophthalate, di-n-decyl isophthalate, diisodecyl isophthalate, di-n-undecyl isophthalate, diisododecyl isophthalate, and/or di-2-propylheptyl phthalate.

Further examples of commercially benzenepolycarboxylic acid esters with which the esters of the cyclohexane carboxylic acids may be used include phthalates such as: Palatinol® AH (Di-(2-ethylhexyl) phthalate; Palatinol® AH L (Di-(2-ethylhexyl) phthalate); Palatinol® N (Diisononyl phthalate); Palatinol® Z (Diisodecyl phthalate) Palatinol® 10-P (Di-(2-Propylheptyl)phthalate); Palatinol® 711P (Heptyl nonyl undecyl phthalate); Palatinol® 911 (Nonylundecyl phthalate); Palatinol® 11P-E (Diundecyl phthalate); Vestinol™ 9. Further examples are the commercially available adipates such as: Plastomoll® DOA (Di-(2-ethylhexyl) adipate) and Plastomoll® DNA (Diisononyl adipate).

In one embodiment the invention therefore provides a plastisol of low viscosity which can be used to produce finished articles with low emissions of volatile organic compounds. The composition also provides additional unexpected benefits during processing and to the properties of articles fabricated from the composition. The performance of the ester of a cyclohexane mono-carboxylic acid when used in the mixture of resin and primary plasticizer is surprising in the light of conventional wisdom as to the theory pertaining to useful non-exuding plasticizers. The compatibility of plasticizer plasticizers with PVC (and their non-exuding behavior) is usually attributed to the presence of diester or triester groups in the plasticizers, or to the combined presence of an ester group and at least one aromatic ring.

The present inventor has also found that the use of C4-C7 secondary aliphatic alcohol esters of cyclohexane polycarboxylic acid esters as plasticizers for polyvinyl chloride also results in improved processability of the polyvinyl chloride compositions. This improved processability is particularly useful in the transformation of the plasticized polyvinyl chloride composition. Transformations include, for example, pelletizing, extrusion, injection molding and calendering. Calendering is used in applications such as the production of roofing, protective films including stationery. Extrusion is used in the production of films, pipes, guttering and wire and cable coatings. Injection molding is used in the production of shoes, toys and the like.

The present invention therefore further provides the use of from 20 to 100 parts preferably from 30 to 90, more preferably from 40 to 80, more preferably from 50 to 70 by weight of a plasticizer composition containing one or more C4-C7 secondary aliphatic alcohol esters of cyclohexane polycarboxylic acid esters per 100 parts of polyvinyl chloride to improve the processability of a polyvinyl chloride formulation.

In a further embodiment the present invention provides a plasticized polyvinyl chloride composition for use in palletizing, extrusion, injection molding or calendering containing from 20 to 100 parts preferably from 30 to 90, more preferably from 40 to 80, more preferably from 50 to 70 by weight of a plasticizer composition containing one or more C4-C7 secondary aliphatic alcohol esters of cyclohexanepolycarboxylic acid esters per 100 parts by weight of polyvinyl chloride.

In a further embodiment the invention provides extruded articles obtained from a plasticized polyvinyl chloride composition containing from 20 to 100, preferably from 30 to 90, more preferably from 40 to 80, more preferably from 50 to 70 parts by weight of a plasticizer composition containing one or more C4-C7 secondary aliphatic alcohol esters of cyclohexane polycarboxylic acid esters per 100 parts of polyvinyl chloride.

In a further embodiment the invention provides pellets comprising polyvinyl chloride and from 10 to 100, preferably from 30 to 90, more preferably from 40 to 80, more preferably from 50 to 70 parts by weight of a plasticizer composition containing one or more C4-C7 secondary aliphatic alcohol esters of cyclohexanepolycarboxylic acid esters per 100 parts of polyvinyl chloride.

In a further embodiment the invention provides injection molded articles obtained from a plasticized polyvinyl chloride composition containing from 20 to 100, preferably from 30 to 90, more preferably from 40 to 80, more preferably from 50 to 70 parts by weight of C4-C7 secondary aliphatic alcohol esters of cyclohexane polycarboxylic acid esters per 100 parts of polyvinyl chloride.

In a further embodiment the invention provides articles obtained by calendering a plasticized polyvinyl chloride composition containing from 20 to 100, preferably from 30 to 90, more preferably from 40 to 80, more preferably from 50 to 70 parts by weight of a plasticizer composition containing one or more C4-C7 secondary aliphatic alcohol esters of cyclohexane polycarboxylic acid esters per 100 parts by weight of polyvinyl chloride.

The present inventor has also found that if esters of C4-C7 secondary aliphatic alcohol esters of cyclohexane polycarboxylic acids are used as plasticizers in one of adjacent layers of plasticized polyvinyl chloride and phthalate plasticizers particularly di-2 ethyl hexyl phthalate are used as plasticizer in the other adjacent layer, the migration of the plasticizer from one layer to the other is reduced as compared with adjacent foils, which contain different of differing amounts of phthalate plasticizer. Undesirably high levels of migration can lead to unsightly crinkling of the multi layer foil.

Accordingly, in a further embodiment the present invention provides a multilayer article in which at least two adjacent layers comprise plasticized polyvinyl chloride wherein the plasticizer in one of said two adjacent layers contains an ester of at least one C4-C7 secondary aliphatic alcohol esters of cyclohexanepolycarboxylic acid.

In a further embodiment, the invention provides the use of any one of the C4-C7 secondary aliphatic alcohol esters of cyclohexanepolycarboxylic acid esters mentioned herein as a plasticizer for polyvinyl chloride to reduce the migration of plasticizer between adjacent layers of plasticized polyvinyl chloride at least one of which contains a phthalate ester, particularly di-2 ethyl hexyl phthalate as plasticizer.

Trade names used herein are indicated by a ™ symbol or ® symbol, indicating that the names may be protected by certain trademark rights, e.g., they may be registered trademarks in various jurisdictions. All patents and patent applications, test procedures (such as ASTM methods, UL methods, and the like), and other documents cited herein are fully incorporated by reference to the extent such disclosure is not inconsistent with this invention and for all jurisdictions in which such incorporation is permitted. When numerical lower limits and numerical upper limits are listed herein, ranges from any lower limit to any upper limit are contemplated. While the illustrative embodiments of the invention have been described with particularity, it will be understood that various other modifications will be apparent to and can be readily made by those skilled in the art without departing from the spirit and scope of the invention.

1. A composition comprising a plasticizable polymer, a first plasticizer selected from at least one C4-C7 secondary aliphatic alcohol ester of a cyclohexanecarboxylic acid, and a second plasticizer, different from said first plasticizer, selected from at least one slow fusing plasticizer, relative to di-2-ethylhexyl phthalate (DEHP).

2. The composition of claim 1, wherein said plasticizable polymer is selected from polyvinyl chloride, polyvinyl acetate, polyvinyl butyral, polystyrene, polyurethanes, acrylics, chlorinated rubber, brominated rubber, polyolefins, and mixtures thereof.

3. The composition of claim 2, wherein said polyolefins are selected from polypropylene, EDPM, thermoplastic elastomers, thermoplastic vulcanizates, and mixtures thereof.

4. The composition of claim 1, wherein said cyclohexanecarboxylic acid is a cyclohexanepolycarboxylic acid.

5. The composition according to claim 4, wherein said cyclohexanepolycarboxylic acid is selected from phthalic acid or anhydride, isophthalic acid or anhydride, and/or terephthalatic acid or dimethyl terephthalate, wherein the acid moiety is hydrogenated before or after esterification with the secondary aliphatic alcohol.

6. The composition according to claim 4, wherein said cyclohexanepolycarboxylic acid is prepared by the Diels Alder condensation of maleic anhydride and butadiene, wherein the acid moiety is hydrogenated before or after esterification with the secondary aliphatic alcohol.

7. The composition according to claim 1, wherein said ester is prepared by the hydrogenation of the C4-C7 secondary aliphatic alcohol phthalate ester.

8. The composition according to claim 1, wherein said ester is prepared by the hydrogenation of the C4-C7 secondary terephthalate ester.

9. The composition according to claim 1, further including at least one additional plasticizer, different from said first and said second plasticizer, selected from at least one fast fusing plasticizer, relative to di-2-ethylhexyl phthalate (DEHP).

10. The composition according to claim 1, wherein said slow fusing plasticizer is selected from di-isodecyl phthalate, di-2-ethylhexyl phthalate, di-isononyl phthalate, di-isooctyl phthalate, di-isononyl cyclohexanedicarboxylic acid ester, di-2-ethylhexyl terephthalate, di-2-propyheptyl phthalate, di-2-propylheptyl cyclohexanedicarboxylic acid ester and mixtures thereof.

11. A plastisol composition comprising the composition according to claim 1, optionally further comprising at least one additive selected from stabilizers, fillers, colorants, and viscosity control agents, wherein said at least one C4-C7 secondary aliphatic alcohol ester of a cyclohexanecarboxylic acid plasticizer is present in the amount of 1 phr to 80 phr, and wherein the total plasticizer concentration is in the amount of 40 phr to 200 phr.

12. The plastisol composition of claim 11, comprising PVC.

13. A multilayer article in which at least two adjacent layers comprise plasticized polyvinyl chloride wherein the plasticizer in one of said two adjacent layers contains an ester of at least one C4-C7 secondary aliphatic alcohol esters of cyclohexanepolycarboxylic acid.
